(19) United States
(12) Patent Application Publication
(10) Pub. No.: US 2026/0094768 A1
(43) Pub. Date: Apr. 2, 2026

(54) ELECTRONIC COMPONENT, ELECTRONIC COMPONENT DEVICE, AND METHOD FOR PRODUCING ELECTRONIC COMPONENT

(71) Applicant: TDK Corporation, Tokyo (JP)

(72) Inventors: Kazuyuki Hasebe, Tokyo (JP); Yuki Okafuji, Tokyo (JP); Yasuhiro Okui, Tokyo (JP); Ken Morita, Tokyo (JP); Noriyuki Inoue, Tokyo (JP)

(73) Assignee: TDK Corporation, Tokyo (JP)

(21) Appl. No.: 19/328,996

(22) Filed: Sep. 15, 2025

(30) Foreign Application Priority Data
Sep. 27, 2024 (JP) 2024-168042

(51) Int. Cl. H01G 4/232; H01G 4/248; H01G 4/30; H01G 13/00

(52) U.S. Cl. CPC H01G 4/2325; H01G 4/248; H01G 4/30; H01G 13/006

(57) ABSTRACT

An electronic component includes an element body and an external electrode. The external electrode is disposed on the element body, and includes a conductive resin layer and a plating layer formed on the conductive resin layer. The external electrode has a hole formed from a surface of the plating layer and reaching the conductive resin layer.

### CROSS-REFERENCE TO RELATED APPLICATIONS

This application is based upon and claims the benefit of priority from Japanese Patent Application No. 2024-168042, filed on Sep. 27, 2024, the entire contents of which are incorporated herein by reference.

### BACKGROUND

### Field

One aspect of the present disclosure relates to an electronic component. Another aspect of the present disclosure relates to an electronic component device. Still another aspect of the present disclosure relates to a method for producing an electronic component.

### Description of the Related Art

Known electronic components include an element body and an external electrode disposed on the element body (see, for example, Japanese Unexamined Patent Publication No. 2008-166666). The external electrode includes, for example, a conductive resin layer and a plating layer formed on the conductive resin layer.

### SUMMARY

The conductive resin layer generally includes a plurality of electrically conductive particles and a resin. The resin tends to absorb moisture. When the electronic component is heated, the moisture absorbed by the resin may be gasified so that volume expansion may occur. In this case, stress may act on the conductive resin layer, and cracks may occur in the conductive resin layer. For example, when the electronic component is solder-mounted on an electronic device, the electronic component is heated. The electronic device includes, for example, a circuit board or an electronic component.

An object of one aspect of the present disclosure is to provide an electronic component that suppresses the occurrence of cracks in the conductive resin layer. An object of another aspect of the present disclosure is to provide an electronic component device that suppresses the occurrence of cracks in the conductive resin layer. An object of still another aspect of the present disclosure is to provide a method for producing an electronic component that suppresses the occurrence of cracks in the conductive resin layer.

An electronic component according to one aspect of the present disclosure includes an element body and an external electrode disposed on the element body, the external electrode including a conductive resin layer and a plating layer formed on the conductive resin layer. The external electrode has a hole that is formed from a surface of the plating layer and reaches the conductive resin layer.

In the one aspect, the hole is formed from the surface of the plating layer and reaches the conductive resin layer. Even if moisture absorbed by the resin is gasified when the electronic component is heated, a gas generated from the moisture moves to the outside of the external electrode through the hole. The hole includes a movement path of the gas. Therefore, stress tends not to act on the conductive resin layer. Consequently, this aspect suppresses the occurrence of cracks in the conductive resin layer.

In the one aspect, the plating layer may include a base plating layer and a solder plating layer disposed on the base plating layer. An inner diameter of the hole in the solder plating layer may be larger than an inner diameter of the hole in the base plating layer.

When the electronic component is solder-mounted on the electronic device, the solder plating layer is wetted with molten solder. In this case, the molten solder may fill the hole.

In a configuration in which the inner diameter of the hole in the solder plating layer is larger than the inner diameter of the hole in the base plating layer, even when the solder plating layer is wetted with the molten solder, the molten solder tends not to fill the hole. Therefore, this configuration reliably suppresses the occurrence of cracks in the conductive resin layer even when the electronic component is solder-mounted on the electronic device.

In the one aspect, the conductive resin layer may include a first portion including a maximum thickness position in the conductive resin layer, and a second portion having a thickness smaller than a thickness of the first portion. The hole may reach the first portion.

The first portion has the thickness larger than the thickness of the second portion. Therefore, the first portion may absorb more the moisture than the second portion.

In a configuration in which the hole reaches the first portion, the hole includes a movement path of the gas from the first portion. The gas generated from the moisture absorbed in the first portion reliably moves to the outside of the external electrode through the hole. Therefore, the stress tends not to act on the first portion of the conductive resin layer. This configuration reliably suppresses the occurrence of cracks in the conductive resin layer.

In the one aspect, the element body may include an end surface, and the external electrode may be positioned on the end surface. The conductive resin layer may include a first portion positioned on a central region of the end surface and a second portion positioned on an outer region of the end surface. The hole may reach the first portion.

The conductive resin layer is formed, for example, through curing a conductive resin paste. The conductive resin paste includes, for example, a curable resin and an organic solvent. The Organic solvent is vaporized. A gas is generated in the conductive resin paste due to vaporization of the organic solvent. The gas generated due to the vaporization of the organic solvent directly reaches a surface of the conductive resin paste from any location within the conductive resin paste where the organic solvent is present, and escapes from the conductive resin paste. In the conductive resin paste, voids are formed at the above-mentioned locations due to the vaporization of the organic solvent, and the voids serve as gas paths. The conductive resin layer tends to include the voids.

The present inventors have newly found that when the conductive resin layer is formed of the conductive resin paste, the first portion tends to include more voids than the second portion.

In a configuration in which the hole reaches the first portion, the hole tends to lead to the voids present in the first portion. The gas generated from the moisture absorbed in the first portion moves from the voids to the hole. Therefore, the gas generated from the moisture tends to move further to the outside of the external electrode. The stress tends not to act further on the conductive resin layer. This configuration suppresses further the occurrence of cracks in the conductive resin layer.

In the one aspect, the hole may reach into the conductive resin layer.

In a configuration in which the hole reaches into the conductive resin layer, the gas generated from the moisture tends to move into the hole. Therefore, the stress tends not to act further on the conductive resin layer. Consequently, this configuration suppresses further the occurrence of cracks in the conductive resin layer.

An electronic component device according to another aspect of the present disclosure includes an electronic component and an electronic device on which the electronic component is solder-mounted. The electronic component includes an element body and an external electrode disposed on the element body, the external electrode including a conductive resin layer and a plating layer formed on the conductive resin layer. The external electrode has a hole formed from a surface of the plating layer and reaching the conductive resin layer. The hole is exposed from a solder.

A method for producing an electronic component according to still another aspect of the present disclosure includes preparing an element body on which an external electrode is formed, the external electrode including a conductive resin layer and a plating layer formed on the conductive resin layer, and forming a hole in the external electrode, the hole reaching the conductive resin layer from a surface of the plating layer.

In the still another aspect, the hole is formed in the external electrode on the prepared element body, the hole reaching the conductive resin layer from the surface of the plating layer. As described above, the hole includes the movement path of the gas generated from moisture. Therefore, in the electronic component obtained from the still another aspect, stress tends not to act on the conductive resin layer. Consequently, the still another aspect obtains the electronic component that suppresses the occurrence of cracks in the conductive resin layer.

In the still another aspect, the forming the hole may include forming the hole to reach into the conductive resin layer.

When the forming the hole includes forming the hole to reach into the conductive resin layer, in the obtained electronic component, as described above, the gas generated from the moisture tends to move into the hole formed in the external electrode. In this case, in the obtained electronic component, the stress tends not to act further on the conductive resin layer, and the occurrence of cracks in the conductive resin layer is further suppressed.

In the still another aspect, the forming the hole may include performing laser irradiation on a surface of the plating layer.

When the forming the hole includes performing the laser irradiation on the surface of the plating layer, the hole is formed through the laser irradiation. Therefore, the hole reaching the conductive resin layer from the surface of the plating layer is easily and reliably formed.

### BRIEF DESCRIPTION OF THE DRAWINGS

FIG. 1 is a perspective view of a multilayer capacitor according to an example;

FIG. 2 is a view illustrating a cross-sectional configuration of the multilayer capacitor;

FIG. 3 is a view illustrating a cross-sectional configuration of the multilayer capacitor;

FIG. 4 is a plan view illustrating an end surface;

FIG. 5 is a view illustrating a planar configuration of an external electrode;

FIG. 6 is a view illustrating a cross-sectional configuration of the external electrode;

FIG. 7 is a view illustrating a planar configuration of an external electrode;

FIG. 8 is a view illustrating a cross-sectional configuration of the external electrode;

FIG. 9 is a schematic view illustrating a producing process of the multilayer capacitor;

FIG. 10 is a view illustrating a cross-sectional configuration of an electronic component device according to another example; and

FIG. 11 is a view illustrating a planar configuration of an external electrode and a solder fillet.

### DETAILED DESCRIPTION

In the following description, with reference to the drawings, the same reference numbers are assigned to the same components or to similar components having the same function, and overlapping description is omitted.

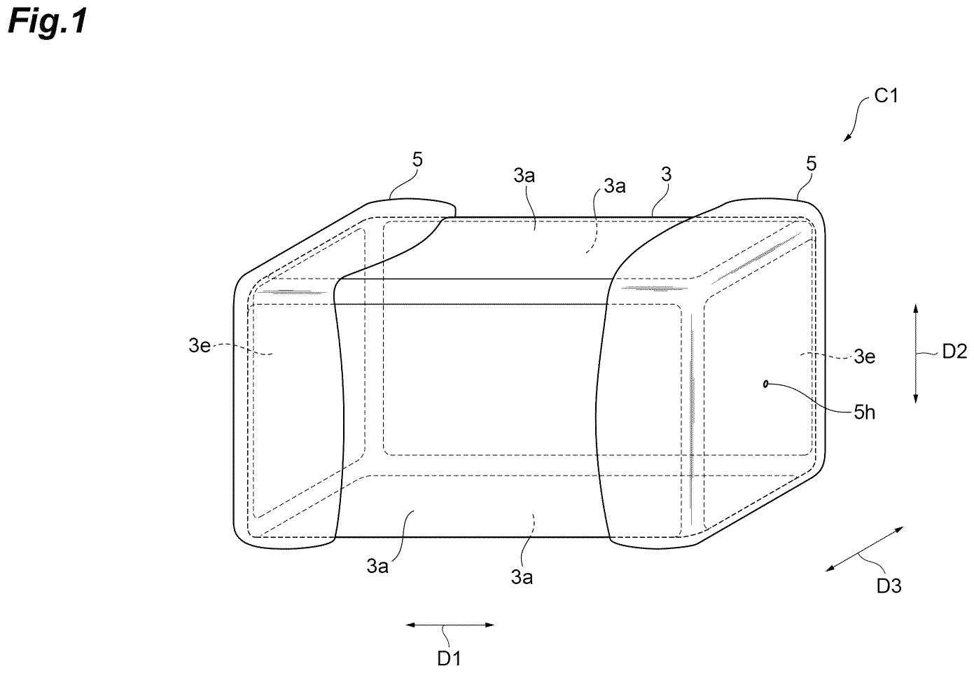

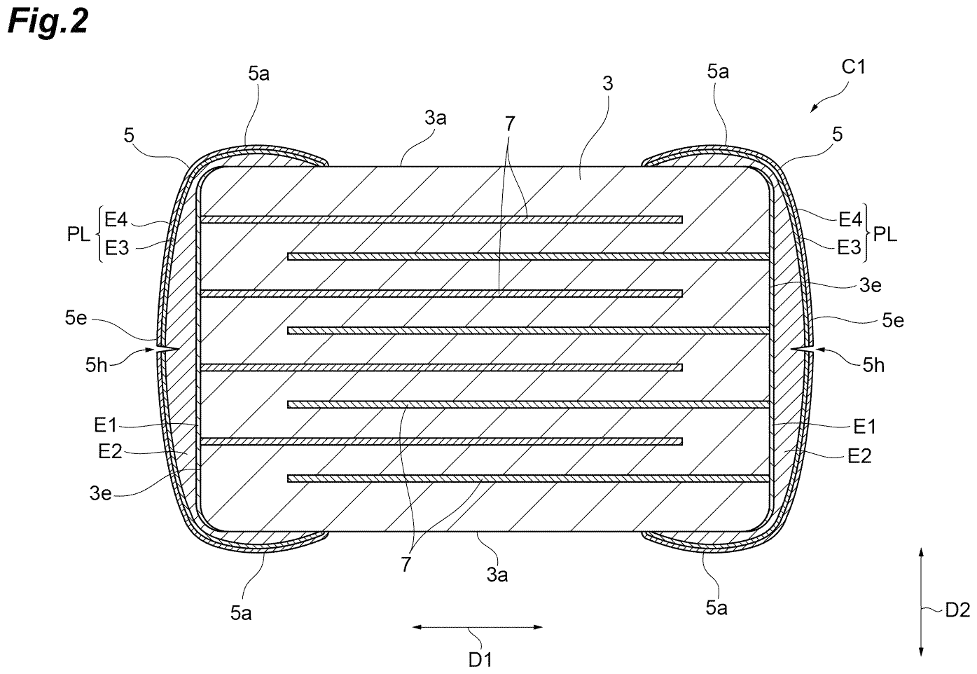

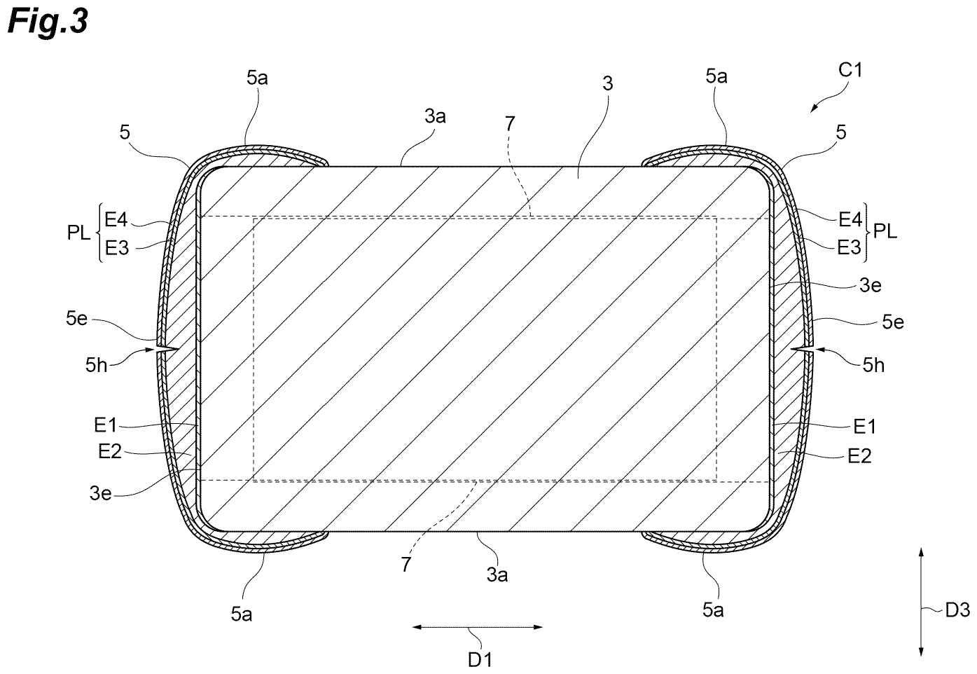

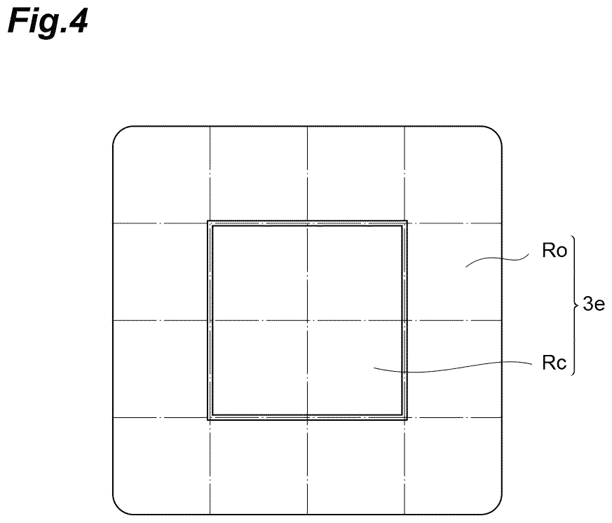

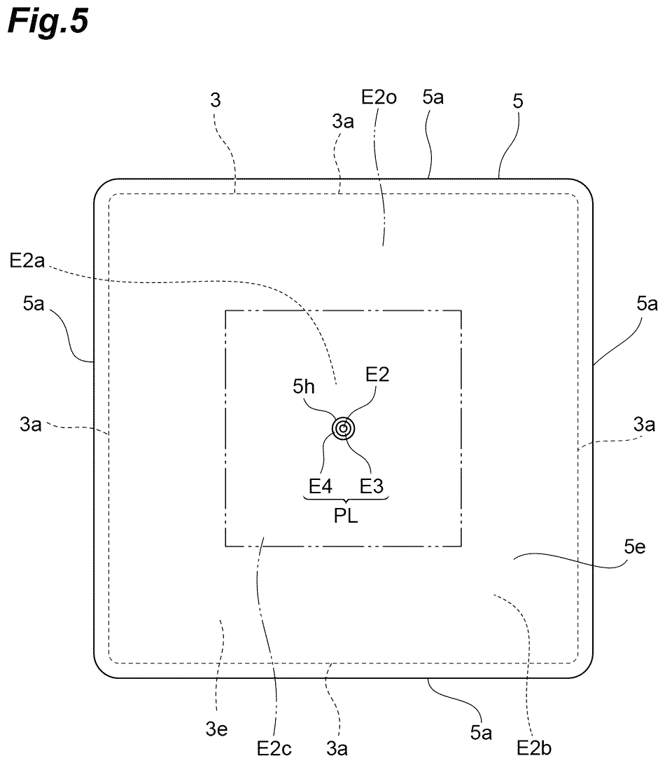

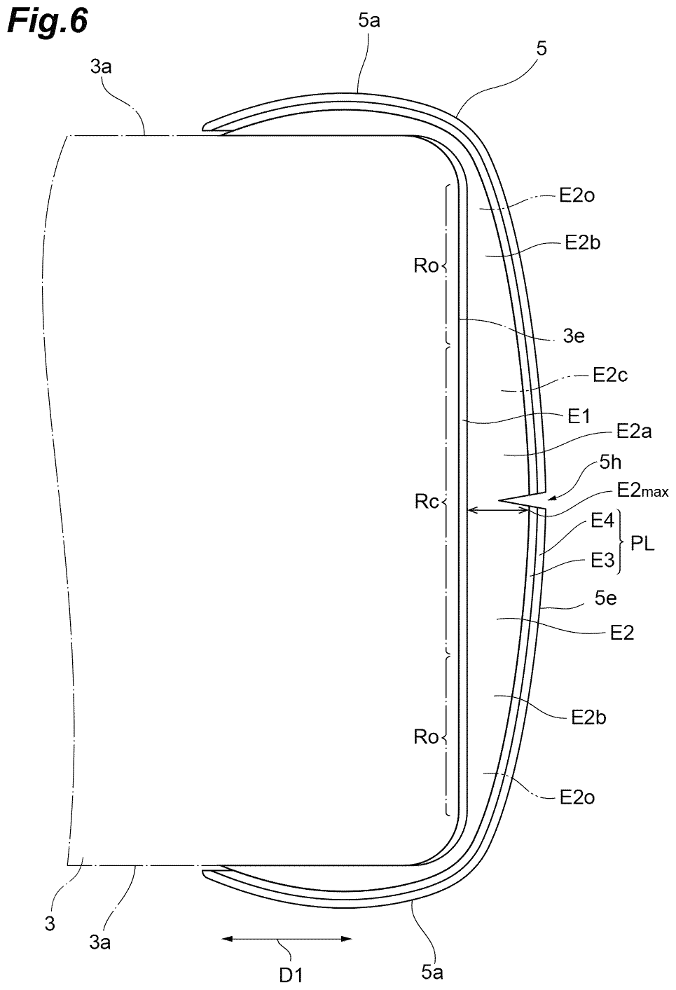

A configuration of a multilayer capacitor C1 according to the example will be described with reference to FIGS. 1 to 6. FIG. 1 is a perspective view of a multilayer capacitor according to the example. FIGS. 2 and 3 are views illustrating a cross-sectional configuration of the multilayer capacitor. FIG. 4 is a plan view illustrating an end surface. FIG. 5 is a view illustrating a planar configuration of an external electrode. FIG. 6 is a view illustrating a cross-sectional configuration of the external electrode. In FIG. 6, hatching indicating a cross section is omitted.

An electronic component includes, for example, the multilayer capacitor C1.

As illustrated in FIG. 1, the multilayer capacitor C1 includes an element body 3 of a rectangular parallelepiped shape and a plurality of external electrodes 5. For example, the multilayer capacitor C1 includes a pair of external electrodes 5. The pair of external electrodes 5 are disposed on a surface of the element body 3. The pair of external electrodes 5 are separated from each other. The rectangular parallelepiped shape includes, for example, a rectangular parallelepiped shape in which corners and ridges are chamfered, or a rectangular parallelepiped shape in which the corners and ridges are rounded.

The element body 3 includes four side surfaces 3a and a pair of end surfaces 3e opposing each other. The four side surfaces 3a and the pair of end surfaces 3e each have a substantially rectangular shape. The four side surfaces 3a include a first pair of side surfaces 3a opposing each other and a second pair of side surfaces 3a opposing each other. A direction in which the first pair of side surfaces 3a oppose each other includes a direction D2. A direction in which the second pair of side surfaces 3a oppose each other includes a direction D3. A direction in which the pair of end surfaces 3e oppose each other includes a direction D1.

The multilayer capacitor C1 is solder-mounted on an electronic device, for example. The electronic device includes, for example, a circuit board or an electronic component. In the multilayer capacitor C1, for example, one of the four side surfaces 3a opposes the electronic device. The one of the four side surfaces 3a is arranged to constitute a mounting surface. The one of the four side surfaces 3a includes the mounting surface.

The direction D2 includes a direction perpendicular to the first pair of side surfaces 3a, and is perpendicular to the direction D3. The direction D1 includes a direction parallel to the four side surfaces 3a, and is perpendicular to the direction D2 and the direction D3. The direction D3 includes a direction perpendicular to the second pair of side surfaces 3a, and the direction D1 includes a direction perpendicular to the end surfaces 3e. For example, a length of the element body 3 in the direction D1 is larger than a length of the element body 3 in the direction D2 and larger than a length of the element body 3 in the direction D3. The direction D1 includes a longitudinal direction of the element body 3. The length of the element body 3 in the direction D2 and the length of the element body 3 in the direction D3 may be equal to each other. The length of the element body 3 in the direction D2 and the length of the element body 3 in the direction D3 may be different from each other.

The length of the element body 3 in the direction D2 defines, for example, a height of the element body 3. The length of the element body 3 in the direction D3 defines, for example, a width of the element body 3. The length of the element body 3 in the direction D1 defines, for example, a longitudinal length of the element body 3. For example, the height of the element body 3 ranges from 0.1 to 3.2 mm, the width of the element body 3 ranges from 0.1 to 6.3 mm, and the longitudinal length of the element body 3 ranges from 0.2 to 7.5 mm. For example, the height of the element body 3 is 1.25 mm, the width of the element body 3 is 1.25 mm, and the longitudinal length of the element body 3 is 2.0 mm.

The first pair of side surfaces 3a extend in the direction D3 to couple the second pair of side surfaces 3a to each other. The first pair of side surfaces 3a extend in the direction D1. The second pair of side surfaces 3a extend in the direction D2 to couple the first pair of side surfaces 3a to each other. The second pair of side surfaces 3a extend in the direction D1. The pair of end surfaces 3e extend in the direction D2 to couple the first pair of side surfaces 3a to each other. The pair of end surfaces 3e extend in the direction D3 to couple the second pair of side surfaces 3a to each other.

The element body 3 includes a ridge portion between the end surface 3e and the side surface 3a and a ridge portion between one of the first pair of side surfaces 3a and one of the second pair of side surfaces 3a. For example, the ridge portions are rounded to be curved. For example, the element body 3 is subjected to what is called a round chamfering process. The end surface 3e and the side surface 3a are indirectly adjacent to each other with the ridge portion between the end surface 3e and the side surface 3a. The one of the first pair of side surfaces 3a and the one of the second pair of side surfaces 3a are indirectly adjacent to each other with the ridge portion between the one of the first pair of side surfaces 3a and the one of the second pair of side surfaces 3a.

The element body 3 is configured through laminating a plurality of dielectric layers in the direction D2. The element body 3 includes a plurality of laminated dielectric layers. In the element body 3, a lamination direction of the plurality of dielectric layers coincides with the direction D2. Each dielectric layer includes, for example, a sintered body of a ceramic green sheet containing a dielectric material. Examples of the dielectric material include dielectric ceramics. Examples of the dielectric ceramics include BaTiO₃-based, Ba(Ti, Zr)O₃-based, or (Ba, Ca)TiO₃-based dielectric ceramics. In the actual element body 3, each of the dielectric layers is integrated to such an extent that a boundary between the dielectric layers cannot be visually recognized.

As illustrated in FIG. 2, the multilayer capacitor C1 includes a plurality of internal electrodes 7. Each of the internal electrodes 7 includes an internal conductor disposed in the element body 3. Each of the internal electrodes 7 is made of an electrically conductive material that is commonly used as an internal conductor of a multilayer electronic component. The electrically conductive material includes, for example, a base metal. The electrically conductive material includes, for example, nickel (Ni) or copper (Cu). Each of the internal electrodes 7 is configured as a sintered body of electrically conductive paste containing the electrically conductive material described above. For example, the internal electrodes 7 include nickel.

The plurality of internal electrodes 7 are disposed in different positions (layers) in the direction D2. The plurality of internal electrodes 7 are disposed in the element body 3 to oppose each other in the direction D2 with an interval therebetween. The internal electrodes 7 adjacent to each other in the direction D2 have different polarities from each other. One end of the internal electrode 7 is exposed at a corresponding end surface 3e of the pair of end surfaces 3e. The internal electrode 7 includes the one end exposed at the corresponding end surface 3e. The plurality of internal electrodes 7 include an internal electrode 7 exposed to one end surface 3e of the pair of end surfaces 3e and an internal electrode 7 exposed to another end surface 3e of the pair of end surfaces 3e. The internal electrodes 7 exposed to the one end surface 3e and the internal electrodes 7 exposed to the other end surface 3e are alternately disposed in the direction D2. The plurality of internal electrodes 7 are disposed in the element body 3 to be distributed in the direction D2. Each of the plurality of internal electrodes 7 is positioned in a plane substantially parallel to the first pair of side surfaces 3a. A direction in which the internal electrodes 7 oppose each other is perpendicular to a direction parallel to the first pair of side surfaces 3a.

In a configuration in which the lamination direction of the plurality of dielectric layers includes the direction D3, the plurality of internal electrodes 7 are disposed in different positions (layers) in the direction D3. In a configuration in which the lamination direction of the plurality of dielectric layers includes the direction D3, the internal electrodes 7 exposed to the one end surface 3e and the internal electrodes 7 exposed to the other end surface 3e are alternately disposed in the direction D3. Each of the plurality of internal electrodes 7 is positioned in a plane substantially parallel to the second pair of side surfaces 3a. The internal electrodes 7 oppose each other in the direction D3.

As illustrated in FIG. 1, the pair of external electrodes 5 are disposed at both ends of the element body 3 in the first direction D1. Each external electrode 5 is disposed on a corresponding end surface 3e of the pair of end surfaces 3e. For example, each external electrode 5 is disposed on the four side surfaces 3a and the one end surface 3e. Each of the external electrodes 5 is positioned on the corresponding end surface 3e. As illustrated in FIGS. 2 and 3, the external electrode 5 includes a plurality of electrode portions 5a and 5e. The electrode portion 5a is positioned on the side surface 3a and on the ridge portion between the side surface 3a and the end surface 3e. The electrode portion 5e is positioned on the end surface 3e. The external electrode 5 includes an electrode portion positioned on the ridge portion between the side surfaces 3a adjacent to each other. Hereinafter, the ridge portion between the side surface 3a and the end surface 3e is referred to as a first ridge portion, and the ridge portion between the side surfaces 3a adjacent to each other is referred to as a second ridge portion.

Each external electrode 5 is formed on five surfaces of the four side surfaces 3a and the end surface 3e as well as the above-described ridge portions. The electrode portions 5a and 5e adjacent to each other are physically coupled and electrically connected. The electrode portion 5e entirely covers the one end of a corresponding internal electrode 7 of the plurality of internal electrodes 7. The electrode portion 5e is directly connected to the corresponding internal electrode 7. The external electrodes 5 are electrically connected to the corresponding internal electrodes 7.

As illustrated in FIGS. 2 to 4, the external electrode 5 includes a first electrode layer E1, a second electrode layer E2, a third electrode layer E3, and a fourth electrode layer E4. The fourth electrode layer E4 includes the outermost layer of the external electrode 5. Each of the electrode portions 5a and 5e includes the first electrode layer E1, the second electrode layer E2, the third electrode layer E3, and the fourth electrode layer E4.

The first electrode layer E1 of the electrode portion 5a is disposed on the first ridge portion and not disposed on the side surface 3a. The first electrode layer E1 of the electrode portion 5a covers the entire first ridge portion. The first electrode layer E1 of the electrode portion 5a does not cover the side surface 3a. The first electrode layer E1 of the electrode portion 5a is in contact with the first ridge portion. The side surface 3a is exposed from the first electrode layer E1. The first electrode layer E1 of the electrode portion 5a may be disposed on the side surface 3a. The first electrode layer E1 of the electrode portion 5a may cover a partial region of the side surface 3a and the entire first ridge portion. The first electrode layer E1 of the electrode portion 5a may be in contact with the partial region of the side surface 3a. The partial region covered with the first electrode layer E1 of the electrode portion 5a may be positioned closer to the end surface 3e.

The second electrode layer E2 of the electrode portion 5a is disposed on both the first electrode layer E1 and the side surface 3a. In the electrode portion 5a, the second electrode layer E2 covers the entire first electrode layer E1 and a partial region of the side surface 3a. The second electrode layer E2 of the electrode portion 5a indirectly covers the first ridge portion such that the first electrode layer E1 is positioned between the second electrode layer E2 and the element body 3. In the electrode portion 5a, the second electrode layer E2 is in direct contact with the first electrode layer E1. The partial region covered with the second electrode layer E2 of the electrode portion 5a is positioned closer to the end surface 3e. The side surface 3a is exposed from the second electrode layer E2 at the remaining region excluding the partial region covered with the second electrode layer E2. In the electrode portion 5a, the second electrode layer E2 is in direct contact with the side surface 3a. In the electrode portion 5a, the second electrode layer E2 directly covers the side surface 3a. The second electrode layer E2 of the electrode portion 5a is positioned on both the side surface 3a and the first ridge portion.

The third electrode layer E3 of the electrode portion 5a is disposed on the second electrode layer E2. In the electrode portion 5a, the third electrode layer E3 covers the second electrode layer E2. In the electrode portion 5a, the third electrode layer E3 is in contact with the second electrode layer E2. In the electrode portion 5a, the third electrode layer E3 is in direct contact with the second electrode layer E2.

The fourth electrode layer E4 of the electrode portion 5a is disposed on the third electrode layer E3. In the electrode portion 5a, the fourth electrode layer E4 covers the third electrode layer E3. In the electrode portion 5a, the fourth electrode layer E4 is in contact with the third electrode layer E3. In the electrode portion 5a, the fourth electrode layer E4 is in direct contact with the third electrode layer E3.

In the electrode portion 5a, the third electrode layer E3 and the fourth electrode layer E4 are not in contact with the side surface 3a. In the electrode portion 5a, the third electrode layer E3 is disposed outside the second electrode layer E2 with a gap between the third electrode layer E3 and the side surface 3a. In the electrode portion 5a, the fourth electrode layer E4 is disposed outside the second electrode layer E2 with a gap between the fourth electrode layer E4 and the side surface 3a. The fourth electrode layer E4 of the electrode portion 5a is disposed outside the third electrode layer E3 of the electrode portion 5a. The third electrode layer E3 and fourth electrode layer E4 of the electrode portion 5a are positioned on the side surface 3a.

For example, in a configuration in which the one side surface 3a of the first pair of side surfaces 3a is arranged to constitute the mounting surface, the second electrode layer E2 of the electrode portion 5a positioned on each of the second pair of side surfaces 3a may cover only a partial region of the ridge portion between the end surface 3e and each of the second pair of side surfaces 3a, and only a partial region of each of the second pair of side surfaces 3a. The partial region of the ridge portion between the end surface 3e and each of the second pair of side surfaces 3a is positioned, for example, closer to the side surface 3a arranged to constitute the mounting surface. The partial region of each of the second pair of side surfaces 3a is positioned, for example, closer to a corner closer to the side surface 3a arranged to constitute the mounting surface and the end surface 3e.

The electrode portion 5a positioned on each of the second pair of side surfaces 3a may have the following configuration. The second electrode layer E2 of the electrode portion 5a positioned on each of the second pair of side surfaces 3a indirectly covers the partial region of the ridge portion between the end surface 3e and each of the second pair of side surfaces 3a such that the first electrode layer E1 is positioned between the second electrode layer E2 and the first ridge portion. The second electrode layer E2 of the electrode portion 5a positioned on each of the second pair of side surfaces 3a directly covers the partial region of each of the second pair of side surfaces 3a. The second electrode layer E2 of the electrode portion 5a positioned on each of the second pair of side surfaces 3a directly covers a partial region of a portion, of the first electrode layer E1, that is positioned on the ridge portion between the end surface 3e and each of the second pair of side surfaces 3a. The electrode portion 5a positioned on each of the second pair of side surfaces 3a includes a region in which the first electrode layer E1 is exposed from the second electrode layer E2 and a region in which the first electrode layer E1 is covered with the second electrode layer E2.

The first electrode layer E1 of the electrode portion 5e is disposed on the end surface 3e. The first electrode layer E1 of the electrode portion 5e covers the entire end surface 3e. The first electrode layer E1 of the electrode portion 5e is in contact with the entire end surface 3e. In the electrode portion 5e, the first electrode layer E1 is in direct contact with the end surface 3e.

The second electrode layer E2 of the electrode portion 5e is disposed on the first electrode layer E1. In the electrode portion 5e, the second electrode layer E2 covers the first electrode layer E1. In the electrode portion 5e, the second electrode layer E2 is in direct contact with the first electrode layer E1. In the electrode portion 5e, the second electrode layer E2 indirectly covers the end surface 3e such that the first electrode layer E1 is positioned between the second electrode layer E2 and the end surface 3e. The second electrode layer E2 of the electrode portion 5e is positioned on the end surface 3e.

The third electrode layer E3 of the electrode portion 5e is disposed on the second electrode layer E2. In the electrode portion 5e, the third electrode layer E3 covers the second electrode layer E2. In the electrode portion 5e, the third electrode layer E3 is in contact with the second electrode layer E2. In the electrode portion 5e, the third electrode layer E3 is in direct contact with the second electrode layer E2. In the electrode portion 5e, the third electrode layer E3 is not in direct contact with the first electrode layer E1.

The fourth electrode layer E4 of the electrode portion 5e is disposed on the third electrode layer E3. In the electrode portion 5e, the fourth electrode layer E4 covers the third electrode layer E3. In the electrode portion 5e, the fourth electrode layer E4 is in contact with the third electrode layer E3. In the electrode portion 5e, the fourth electrode layer E4 is in direct contact with the third electrode layer E3.

In the electrode portion 5e, the third electrode layer E3 and the fourth electrode layer E4 are disposed outside the second electrode layer E2. The fourth electrode layer E4 of the electrode portion 5e is disposed outside the third electrode layer E3 of the electrode portion 5e. The third electrode layer E3 and fourth electrode layer E4 of the electrode portion 5e are positioned on the end surface 3e.

The second electrode layer E2 of the electrode portion 5e may cover only a partial region of the end surface 3e. The partial region of the end surface 3e is positioned closer to the side surface 3a, for example. The electrode portion 5e may have the following configuration. The second electrode layer E2 of the electrode portion 5e indirectly covers the partial region of the end surface 3e such that the first electrode layer E1 is positioned between the second electrode layer E2 and the end surface 3e. The second electrode layer E2 of the electrode portion 5e directly covers only a partial region of a portion, of the first electrode layer E1, that is positioned on the end surface 3e. The electrode portion 5e includes a region in which the first electrode layer E1 is exposed from the second electrode layer E2 and a region in which the first electrode layer E1 is covered with the second electrode layer E2.

The second electrode layer E2 of the electrode portion 5e includes a maximum thickness position E2ₘₐₓ. In the electrode portion 5e, the second electrode layer E2 has the largest thickness at the maximum thickness position E2ₘₐₓ. The thickness of the second electrode layer E2 of the electrode portion 5e decreases from the maximum thickness position E2ₘₐₓ toward an end of the electrode portion 5e. Therefore, the second electrode layer E2 of the electrode portion 5e includes a portion E2a including the maximum thickness position E2ₘₐₓ and a portion E2b having a thickness smaller than the thickness of the portion E2a. When viewed from the direction D1, the portion E2a is positioned inside the portion E2b. The portion E2a may include a first portion, and the portion E2b may include a second portion. The thickness of the second electrode layer E2 at the maximum thickness position E2ₘₐₓ is 10 μm or more. The thickness of the second electrode layer E2 at the maximum thickness position E2ₘₐₓ is, for example, 70 μm.

The first electrode layer E1 is formed from sintering electrically conductive paste applied onto the surface of the element body 3. The electrically conductive paste is applied onto the end surface 3e and the first ridge portions. The first electrode layer E1 is formed to cover the end surface 3e and the first ridge portions. The first electrode layer E1 is formed from sintering a metal component (metal particles) included in the electrically conductive paste. The first electrode layer E1 includes, for example, a sintered metal layer. The first electrode layer E1 includes the sintered metal layer formed on the element body 3. For example, the first electrode layer E1 includes a sintered metal layer made of copper. The first electrode layer E1 may include a sintered metal layer made of nickel. The first electrode layer E1 may include a base metal. The electrically conductive paste may include, for example, particles made of copper or nickel, a glass component, an organic binder, and an organic solvent. For example, the first electrode layers E1 included in the electrode portions 5a and 5e are formed integrally with each other.

The second electrode layer E2 is formed from curing conductive resin paste applied onto the first electrode layer E1. The conductive resin paste is applied onto the first electrode layer E1 and the partial regions of the side surfaces 3a. The second electrode layer E2 is formed on both the first electrode layer E1 and the element body 3. The conductive resin paste includes, for example, a plurality of electrically conductive particles, a resin, and an organic solvent. The resin may include a thermosetting resin. The thermosetting resin may include a phenol resin, an acrylic resin, a silicone resin, an epoxy resin, or a polyimide resin. The second electrode layer E2 is in contact with a part of the second ridge portion. For example, the second electrode layers E2 included in the electrode portions 5a and 5e are integrally formed with each other.

The second electrode layer E2 includes a portion E2c positioned on a central region Rc of the end surface 3e and a portion E2o positioned on an outer region Ro of the end face 3e. The outer region Ro is positioned outside the central region Rc. The portion E2o is positioned outside the portion E2c. The second electrode layer E2 of the electrode portion 5e includes the portion E2c and the portion E2o. The portion E2c may include a first portion, and the portion E2o may include a second portion.

The central region Rc and the outer region Ro of the end face 3e are defined, for example, as follows. As illustrated in FIG. 4, the end surface 3e is divided into sixteen sections, the four sections, of the sixteen sections, that are positioned on the inner side are defined as the central region Rc, and the twelve sections, of the sixteen sections, that are positioned on the outer side are defined as the outer region Ro.

When viewed from the direction D1, the portion E2a may coincide with the portion E2c, and the portion E2b may coincide with the portion E2o. The portion E2a may be larger or smaller than the portion E2c as viewed from the direction D1. The portion E2b may be larger or smaller than the portion E2o as viewed from the direction D1.

The third electrode layer E3 is formed on the second electrode layer E2 through a plating process. The third electrode layer E3 may include, for example, a nickel plating layer. The third electrode layer E3 may include nickel. The nickel plating layer tends to have better solder leach resistance than the electrically conductive particle included in the second electrode layer E2. The third electrode layer E3 covers the second electrode layer E2.

The fourth electrode layer E4 is formed on the third electrode layer E3 through a plating process. The third electrode layer E3 includes a base plating layer on which the fourth electrode layer E4 is formed. The fourth electrode layer E4 includes, for example, a solder plating layer. The solder plating layer may include a tin (Sn) plating layer. The fourth electrode layer E4 may include tin. The fourth electrode layer E4 may include a tin-silver alloy (Sn—Ag) plating layer, a tin-bismuth alloy (Sn—Bi) plating layer, or a tin-copper alloy (Sn—Cu) plating layer. The fourth electrode layer E4 covers the third electrode layer E3.

The third electrode layer E3 and the fourth electrode layer E4 are included in a plating layer PL formed on the second electrode layer E2. The external electrode 5 includes the plating layer PL, and the plating layer PL includes the third electrode layer E3 and the fourth electrode layer E4. The plating layer PL covers the second electrode layer E2. For example, the third electrode layers E3 included in the electrode portions 5a and 5e are formed integrally with each other. For example, the fourth electrode layers E4 included in the electrode portions 5a and 5e are formed integrally with each other. The plating layer PL may include another plating layer between the second electrode layer E2 and the third electrode layer E3. The plating layer PL may include another plating layer between the third electrode layer E3 and the fourth electrode layer E4.

As illustrated in FIGS. 5 and 6, each external electrode 5 has a hole 5h. The hole 5h is formed in the electrode portion 5e. The number of holes 5h is, for example, one. The hole 5h is formed from the surface of the plating layer PL and reaches the second electrode layer E2. The hole 5h is formed from the surface of the fourth electrode layer E4. The hole 5h penetrates the plating layer PL. The hole 5h reaches the portion E2a of the second electrode layer E2. The hole 5h reaches a portion E2c of the second electrode layer E2.

The deepest position of the hole 5h is positioned within the second electrode layer E2. The deepest position of the hole 5h is positioned closer to the element body 3 than the interface between the second electrode layer E2 and the plating layer PL in the direction D1, and is positioned closer to the plating layer PL than the interface between the second electrode layer E2 and the first electrode layer E1. The hole 5h reaches into the second electrode layer E2. The hole 5h reaches into the portion E2a of the second electrode layer E2. The hole 5h reaches into the portion E2c of the second electrode layer E2. The hole 5h does not penetrate the second electrode layer E2. The maximum value of the depth of the hole 5h in the second electrode layer E2 is smaller than the thickness of the second electrode layer E2 at the position where the hole 5h is to be formed. The depth of the hole 5h in the second electrode layer E2 is, for example, 1 μm or more.

The third electrode layer E3 is exposed in the hole 5h. The third electrode layer E3 is exposed from the fourth electrode layer E4 in the hole 5h, and is not covered with the fourth electrode layer E4. The second electrode layer E2 is exposed in the hole 5h. The second electrode layer E2 is exposed from the fourth electrode layer E4 in the hole 5h, and is not covered with the fourth electrode layer E4. The second electrode layer E2 is separated from the fourth electrode layer E4 on the inner surface defining the hole 5h. The hole 5h does not reach the first electrode layer E1. Therefore, the first electrode layer E1 is not exposed at the hole 5h.

The inner diameter of the hole 5h in the fourth electrode layer E4 may be larger than the inner diameter of the hole 5h in the third electrode layer E3. In a configuration in which the inner diameter of the hole 5h in the fourth electrode layer E4 is larger than the inner diameter of the hole 5h in the third electrode layer E3, the hole 5h, for example, is reduced in diameter from the opening at the surface of the plating layer PL toward the deepest position. For example, the inner diameter of the hole 5h in the fourth electrode layer E4 ranges from 1 to 70 μm. For example, the inner diameter of the hole 5h in the third electrode layer E3 ranges from 1 to 30 μm. For example, the ratio of the inner diameter of the hole 5h in the third electrode layer E3 to the inner diameter of the hole 5h in the fourth electrode layer E4 ranges from ¼ to ⅔. The inner diameter of the hole 5h in the fourth electrode layer E4 is defined, for example, by the inner diameter of the opening of the hole 5h at the surface of the fourth electrode layer E4. The inner diameter of the hole 5h in the third electrode layer E3 is defined, for example, by the inner diameter of the opening of the hole 5h at the surface of the third electrode layer E3, that is, at the interface between the fourth electrode layer E4 and the third electrode layer E3.

The inner diameter of the hole 5h in the second electrode layer E2 is, for example, smaller than the inner diameter of the hole 5h in the third electrode layer E3. For example, the inner diameter of the hole 5h in the second electrode layer E2 ranges from 1 to 30 μm. The inner diameter of the hole 5h in the second electrode layer E2 is defined, for example, by the inner diameter of the opening of the hole 5h at the surface of the second electrode layer E2, that is, at the interface between the third electrode layer E3 and the second electrode layer E2.

The opening of the hole 5h in the fourth electrode layer E4 has, for example, a substantially circular shape. The opening of the hole 5h in the third electrode layer E3 has, for example, a substantially circular shape. The opening of the hole 5h in the second electrode layer E2 has, for example, a substantially circular shape. Each opening of the hole 5h may have a shape other than a circular shape. Each opening of the hole 5h may have a substantially polygonal shape. In a configuration in which the opening of the hole 5h does not have a circular shape, the inner diameter of the hole 5h is defined, for example, as follows. After the area of the opening of the hole 5h is obtained, the equivalent circle diameter of this area is calculated. The calculated equivalent circle diameter defines the inner diameter of the hole 5h. In a configuration in which the plating layer PL includes another plating layer between the third electrode layer E3 and the fourth electrode layer E4, the inner diameter of the hole 5h in the other plating layer is, for example, larger than the inner diameter of the hole 5h in the third electrode layer E3 and smaller than the inner diameter of the hole 5h in the fourth electrode layer E4.

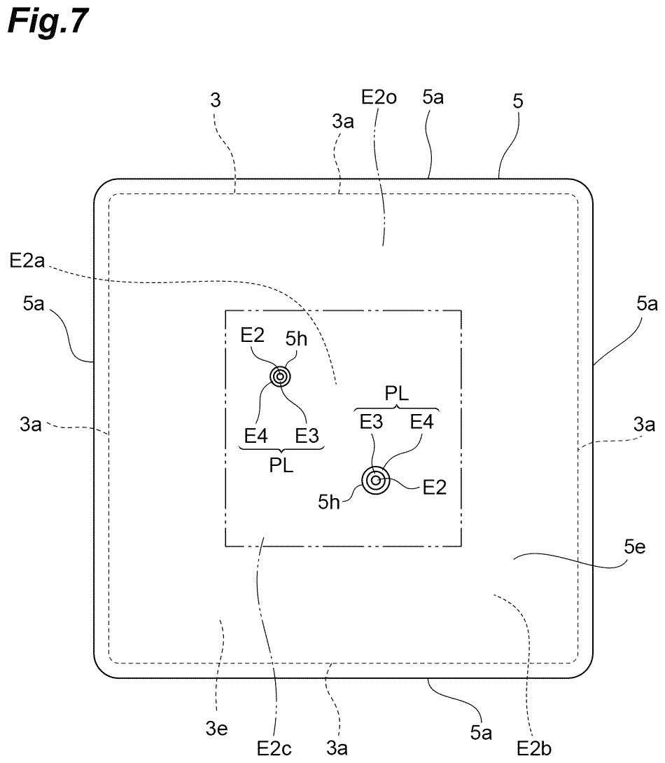

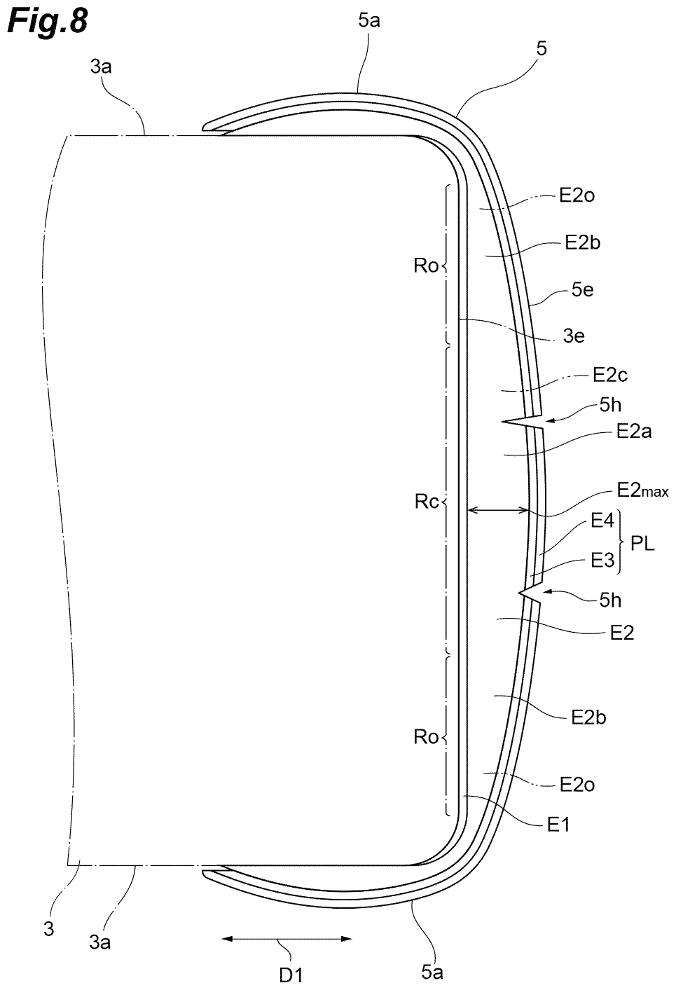

As illustrated in FIGS. 7 and 8, each of the external electrodes 5 may have a plurality of holes 5h. FIG. 7 is a view illustrating a planar configuration of an external electrode. FIG. 8 is a view illustrating a cross-sectional configuration of the external electrode. In FIG. 8, hatching indicating a cross section is omitted.

In a configuration in which the external electrode 5 has a plurality of holes 5h, the plurality of holes 5h may be formed in the electrode portion 5e. Each of the plurality of holes 5h is formed from the surface of the plating layer PL and reaches the second electrode layer E2. Each of the plurality of holes 5h may reach the portion E2a. Each of the plurality of holes 5h may reach the portion E2c. The plurality of holes 5h may be different from each other in shape or depth. Although not illustrated, the plurality of holes 5h may include a hole 5h reaching the portion E2b in addition to the hole 5h reaching the portion E2a, and the plurality of holes 5h may include a hole 5h reaching the portion E2o in addition to the hole 5h reaching the portion E2c.

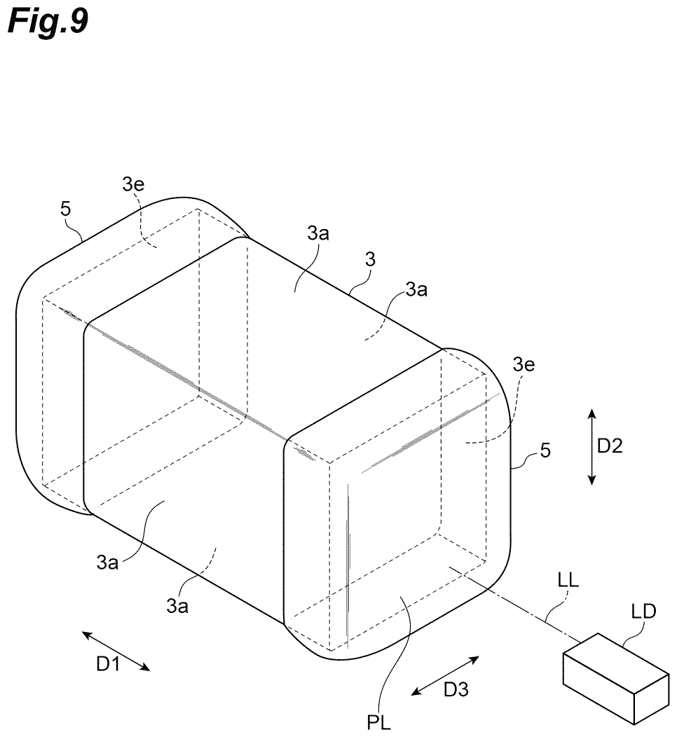

A producing process of the multilayer capacitor C1 will be described with reference to FIG. 9. FIG. 9 is a schematic diagram showing a producing process of the multilayer capacitor according to the present example.

The producing process of the multilayer capacitor C1 includes preparing the element body 3 on which the external electrode 5 is formed and forming the hole 5h in the external electrode 5. As described above, the external electrode 5 formed on the element body 3 includes the first electrode layer E1, the second electrode layer E2, and the plating layer PL (the third electrode layer E3 and the fourth electrode layer E4). The producing process of the element body 3 is well known in this technical field, and therefore a detailed description thereof will be omitted.

The forming the hole 5h includes forming the hole 5h reaching the second electrode layer E2 from the surface of the plating layer PL. The hole 5h is formed from the outside of the external electrodes 5. The forming the hole 5h may include forming the hole 5h reaching the second electrode layer E2 from the surface of the plating layer PL.

As illustrated in FIG. 9, the hole 5h is formed, for example, through laser irradiation. The forming the hole 5h includes performing laser irradiation on the surface of the external electrode 5, that is, the surface of the plating layer PL. The laser irradiation is performed by a laser irradiation device LD. The laser irradiation device LD includes a laser light source (not illustrated), and irradiates the surface of the plating layer PL with laser light LL from the laser light source. The depth and the inner diameter of the hole 5h are adjusted, for example, through adjusting conditions of the laser irradiation. The conditions of the laser irradiation include, for example, the pulse energy of the laser light LL or the irradiation time of the laser light LL. The hole 5h may be formed by micro-hole machining through cutting.

In the multilayer capacitor C1, the hole 5h of the external electrode 5 is formed from the surface of the plating layer PL and reaches the second electrode layer E2. Even if moisture absorbed by the resin of the second electrode layer E2 is gasified when the multilayer capacitor C1 is heated, a gas generated from the moisture moves to the outside of the external electrode 5 through the hole 5h. The hole 5h includes a movement path of the gas. Therefore, stress tends not to act on the second electrode layer E2. Consequently, the multilayer capacitor C1 suppresses the occurrence of cracks in the second electrode layer E2.

In the multilayer capacitor C1, the plating layer PL may include the third electrode layer E3 and the fourth electrode layer E4. The fourth electrode layer E4 may include the solder plating layer. The inner diameter of the hole 5h in the fourth electrode layer E4 may be larger than the inner diameter of the hole 5h in the third electrode layer E3.

When the multilayer capacitor C1 is solder-mounted on the electronic device, the fourth electrode layer E4 is wetted with molten solder. In this case, the molten solder may fill the hole 5h.

In a configuration in which the inner diameter of the hole 5h in the fourth electrode layer E4 is larger than the inner diameter of the hole 5h in the third electrode layer E3, even when the fourth electrode layer E4 is wetted with the molten solder, the molten solder tends not to fill the hole 5h. Therefore, the multilayer capacitor C1 having this configuration reliably suppresses the occurrence of cracks in the second electrode layer E2 even when the multilayer capacitor C1 is solder-mounted on the electronic device.

In the multilayer capacitor C1, the second electrode layer E2 may include the portion E2a including the maximum thickness position E2ₘₐₓ in the second electrode layer E2, and the portion E2b having the thickness smaller than the thickness of the portion E2a. The hole 5h may reach the portion E2a.

The portion E2a has the thickness larger than the thickness of the portion E2b. Therefore, the portion E2a may absorb more moisture than the portion E2b.

In a configuration in which the hole 5h reaches the portion E2a, the hole 5h includes a movement path of the gas from the portion E2a. The gas generated from the moisture absorbed in the portion E2a reliably moves to the outside of the external electrode 5 through the hole 5h. Therefore, the stress tends not to act on the portion E2a of the second electrode layer E2. The multilayer capacitor C1 having this configuration reliably suppresses the occurrence of cracks in the second electrode layer E2.

In the multilayer capacitor C1, the element body 3 may include the end surface 3e, and the external electrode 5 may be positioned on the end surface 3e. The second electrode layer E2 may include the portion E2c positioned on the central region Rc of the end surface 3e and the portion E2o positioned on the outer region Ro of the end surface 3e. The hole 5h may reach the portion E2c.

The second electrode layer E2 is formed, for example, through curing the conductive resin paste. The conductive resin paste includes, for example, the curable resin and the organic solvent. The organic solvent is vaporized. A gas is generated in the conductive resin paste due to vaporization of the organic solvent. The gas generated due to the vaporization of the organic solvent directly reaches the surface of the conductive resin paste from any location within the conductive resin paste where the organic solvent is present, and escapes from the conductive resin paste. In the conductive resin paste, voids are formed at the above-mentioned locations due to the vaporization of the organic solvent, and the voids serve as gas paths. The second electrode layer E2 tends to include the voids.

The present inventors have newly found that when the second electrode layer E2 is formed of the conductive resin paste, the portion E2c tends to include more voids than the portion E2o.

In a configuration in which the hole 5h reaches the portion E2c, the hole 5h tends to lead to the voids present in the portion E2c. The gas generated from the moisture absorbed in the portion E2c moves from the voids to the hole 5h. Therefore, the gas generated from the moisture tends to move further to the outside of the external electrode 5. The stress tends not to act further on the second electrode layer E2. The multilayer capacitor C1 having this configuration suppresses further the occurrence of cracks in the second electrode layer E2.

In the multilayer capacitor C1, the hole 5h may reach into the second electrode layer E2.

In a configuration in which the hole 5h reaches into the second electrode layer E2, the gas generated from the moisture tends to move into the hole 5h. Therefore, the stress tends not to act further on the second electrode layer E2. Consequently, this configuration suppresses further the occurrence of cracks in the second electrode layer E2.

In the producing process of the multilayer capacitor C1, the hole 5h is formed in the external electrode 5 on the prepared element body 3, the hole 5h reaching the second electrode layer E2 from the surface of the plating layer PL. As described above, the hole 5h includes the movement path of the gas generated from the moisture absorbed by the resin of the second electrode layer E2. Therefore, in the multilayer capacitor C1, the stress tends not to act on the second electrode layer E2.

Consequently, through the producing process described above, the multilayer capacitor C1 that suppresses the occurrence of cracks in the second electrode layer E2 is obtained.

In the producing process described above, the forming the hole 5h may include forming the hole 5h to reach into the second electrode layer E2.

When the forming the hole 5h includes forming the hole 5h to reach into the second electrode layer E2, in the obtained multilayer capacitor C1, as described above, the gas generated from the moisture tends to move into the hole 5h. In this case, in the obtained multilayer capacitor C1, the stress tends not to act further on the second electrode layer E2, and the occurrence of cracks in the second electrode layer E2 is further suppressed.

In the producing process described above, the forming the hole 5h may include performing the laser irradiation on the surface of the plating layer PL.

When the forming the hole 5h includes performing the laser irradiation on the surface of the plating layer PL, the hole 5h is formed through the laser irradiation. Therefore, the hole 5h reaching the second electrode layer E2 from the surface of the plating layer PL is easily and reliably formed.

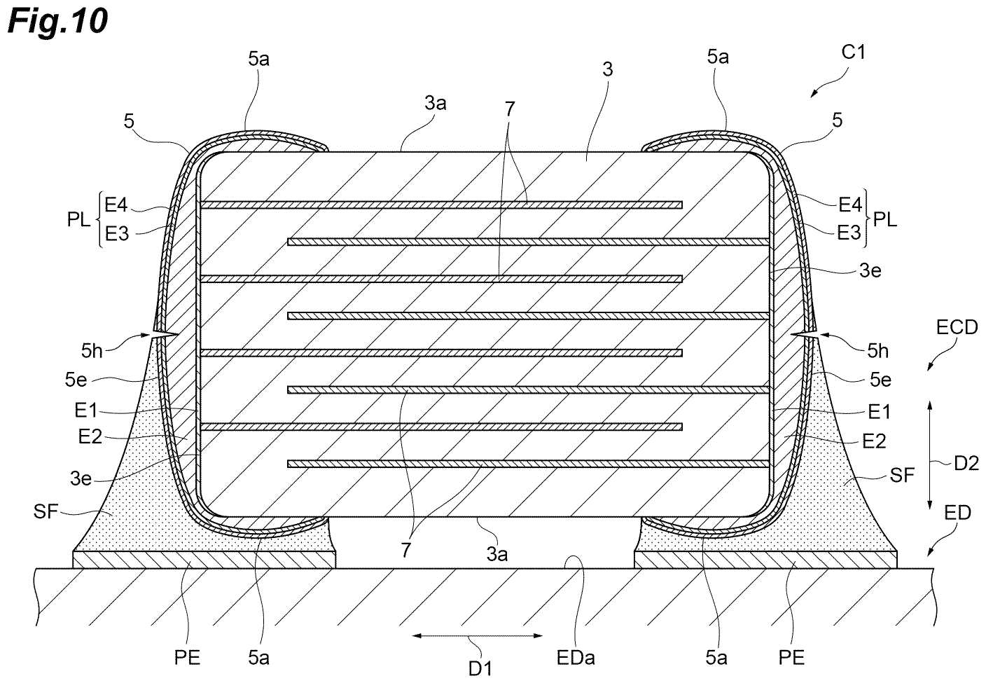

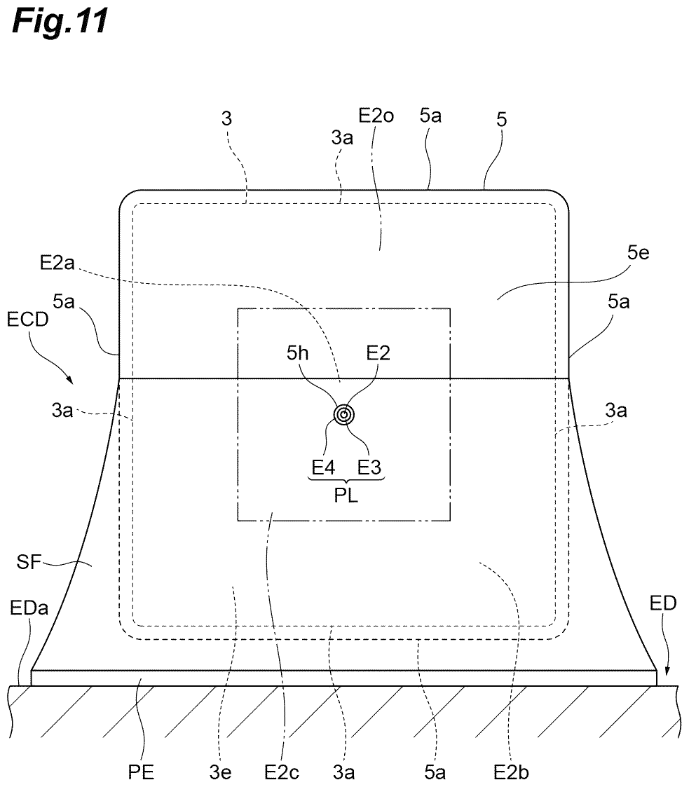

A configuration of an electronic component device ECD according to another example will be described with reference to FIGS. 10 to 11. FIG. 10 is a view illustrating a cross-sectional configuration of an electronic component device according to another example. FIG. 11 is a view illustrating a planar configuration of an external electrode and a solder fillet.

The electronic component device ECD includes the multilayer capacitor C1 and an electronic device ED. The electronic device ED includes, for example, a circuit board or an electronic component. The multilayer capacitor C1 is solder-mounted on the electronic device ED. The electronic device ED includes a main surface EDa and a pair of pad electrodes PE. Each pad electrode PE is disposed on the main surface EDa. The pair of pad electrodes PE are separated from each other. The multilayer capacitor C1 is disposed on the electronic device ED in such a manner that one of the side surfaces 3a and the main surface EDa oppose each other.

In solder-mounting the multilayer capacitor C1, the molten solder wets the external electrode 5 (fourth electrode layer E4). Solidification of the wet solder causes a solder fillet SF to be formed on each external electrode 5. The external electrodes 5 and the pad electrodes PE corresponding to each other are coupled to each other through the solder fillet SF.

The hole 5h is exposed from the solder fillet SF. The hole 5h is exposed from the solidified solder. The solidified solder tends not to fill the hole 5h. The solidified solder tends not to suppress the movement of the gas generated from moisture to the outside of the external electrode 5. In the electronic component device ECD, the multilayer capacitor C1 suppresses the occurrence of cracks in the second electrode layer E2.

It is to be understood that not all aspects, advantages and features described herein may necessarily be achieved by, or included in, any one particular example. Indeed, having described and illustrated various examples herein, it should be apparent that other examples may be modified in arrangement and detail.

The inner diameter of the hole 5h in the fourth electrode layer E4 may not be larger than the inner diameter of the hole 5h in the third electrode layer E3. In a configuration in which the inner diameter of the hole 5h in the fourth electrode layer E4 is larger than the inner diameter of the hole 5h in the third electrode layer E3, this configuration reliably suppresses the occurrence of cracks in the second electrode layer E2, as described above.

In the present examples and modified examples, the electronic component includes the multilayer capacitor. However, applicable electronic component is not limited to the multilayer capacitor. The applicable electronic component includes, for example, a multilayer electronic component such as a multilayer inductor, a multilayer varistor, a multilayer piezoelectric actuator, a multilayer thermistor, a multilayer solid-state battery component, or a multilayer composite component, or electronic components other than the multilayer electronic components.

What is claimed is:

1. An electronic component comprising:
an element body; and
an external electrode disposed on the element body and including a conductive resin layer and a plating layer formed on the conductive resin layer, wherein
the external electrode has a hole formed from a surface of the plating layer and reaching the conductive resin layer.

2. The electronic component according to claim 1, wherein
the plating layer includes a base plating layer and a solder plating layer disposed on the base plating layer, and
an inner diameter of the hole in the solder plating layer is larger than an inner diameter of the hole in the base plating layer.

3. The electronic component according to claim 1, wherein
the conductive resin layer includes a first portion including a maximum thickness position in the conductive resin layer, and a second portion having a thickness smaller than a thickness of the first portion, and
the hole reaches the first portion.

4. The electronic component according to claim 1, wherein
the element body includes an end surface,
the external electrode is positioned on the end surface,
the conductive resin layer includes a first portion positioned on a central region of the end surface and a second portion positioned on an outer region of the end surface, and
the hole reaches the first portion.

5. The electronic component according to claim 1, wherein
the hole reaches into the conductive resin layer.

6. An electronic component device comprising:
an electronic component; and
an electronic device on which the electronic component is solder-mounted, wherein
the electronic component includes:
an element body; and
an external electrode disposed on the element body and including a conductive resin layer and a plating layer formed on the conductive resin layer,
the external electrode has a hole formed from a surface of the plating layer and reaching the conductive resin layer, and
the hole is exposed from a solder.

7. The electronic component device according to claim 6, wherein
the plating layer includes a base plating layer and a solder plating layer disposed on the base plating layer, and
an inner diameter of the hole in the solder plating layer is larger than an inner diameter of the hole in the base plating layer.

8. The electronic component device according to claim 6, wherein
the conductive resin layer includes a first portion including a maximum thickness position in the conductive resin layer, and a second portion having a thickness smaller than a thickness of the first portion, and
the hole reaches the first portion.

9. The electronic component device according to claim 6, wherein
the element body includes an end surface,
the external electrode is positioned on the end surface,
the conductive resin layer includes a first portion positioned on a central region of the end surface and a second portion positioned on an outer region of the end surface, and
the hole reaches the first portion.

10. The electronic component device according to claim 6, wherein
the hole reaches into the conductive resin layer.

11. A method for producing an electronic component, the method comprising:
preparing an element body on which an external electrode is formed, the external electrode including a conductive resin layer and a plating layer formed on the conductive resin layer; and
forming a hole in the external electrode, the hole reaching the conductive resin layer from a surface of the plating layer.

12. The method for producing an electronic component according to claim 11, wherein
the forming the hole includes forming the hole to reach into the conductive resin layer.

13. The method for producing an electronic component according to claim 11, wherein
the forming the hole includes performing laser irradiation on a surface of the plating layer.
